(19) United States
(12) Patent Application Publication
(10) Pub. No.: US 2001/0015616 A1
(43) Pub. Date: Aug. 23, 2001

(54) Temperature compensated grid system for flat panel displays

(76) Inventors: Marbert G. Moore III, Los Gatos, CA (US); Jessica L. Stevens, San Mateo, CA (US)

Correspondence Address: TELEGEN CORPORATION, 1840 GATEWAY DRIVE, SUITE 200, SAN MATEO, CA, 94404, US

(21) Appl. No.: 09/817,645

(22) Filed: Mar. 26, 2001

Related U.S. Application Data
(63) Continuation-in-part of application No. 08/874,354, filed on Jun. 13, 1997.

(51) Int. Cl. H01J 1/62; H01J 63/04

(52) U.S. Cl. 313/497; 313/422

(57) ABSTRACT

In flat panel displays wherein thermionic electrons are focused to a narrow beam by means of an anode or gating grids, such grids structures are subjected to temperature deformation and vibratory stress. In high resolution displays individual grid structures are placed in close proximity to similar structures, often less than 0.0265 inch apart. Failure to accommodate physical deformation due to wide variations in temperature and or physical stress caused by shock and vibration will cause the grid wires to short circuit and the display to fail. The invention operates to maintain the relative separation of the individual grid structures within a range of temperatures, shock, and vibration.

### CROSS-REFERENCE TO RELATED APPLICATIONS

This application is a Continuation In Part of application Ser. No. 08/874,354, filed Jun. 13, 1997.

### BACKGROUND

1. Field of the Invention

The present invention relates to the field of flat display devices, in particular display devices using a deflection mechanism to guide low-energy electrons into a narrow beam for illumination of such displays.

2. Description of Prior Art

Fluorescent displays using materials such as phosphors that emit light when impinged by electrons are in the prior art. Generally, displays operating according to this technique employ one or more cathodes that provide a source of electrons, one or more anodes for attracting the electrons to a phosphor screen, and a control system positioned between the cathodes and anodes for selectively guiding the electrons to specific locations on the screen.

Numerous cathode sources are available for generating the electrons for such displays. Some of the common methods are based on cold cathode field emission, light stimulated electron emission, plasma generation and thermal generation of electrons.

In one type of flat panel display, spatially distributed cathodes emit a cloud of electrons over an area equal in size to the display area. A control system comprising a set of orthogonal electrodes guides electrons out of the large-area electron cloud for acceleration to specific phosphor-coated anodes in an anode matrix.

Prior art controls for such flat-panel systems can consist of simple crossed electrodes as described in U.S. Pat. No. 4,368,404 to Daisyaku. Here thermal electrons are emitted from cathode filaments positioned behind a control grid of thin wires that, in turn, are positioned behind an anode matrix of thin wires.

In all presently known grid-controlled systems each grid wire must be separated from the next one by a minimum distance to prevent short-circuiting between them. This minimum distance determines a maximum number of pixels per inch or resolution of the screen display. Thus, a higher density of grid wires yields a higher resolution for the display.

Because there is a large temperature variation within such displays, thermal expansion can cause the wires in such displays to sag. Loss of tension in the wires, however, can result in short circuits, dangerous vibrations, and loss in resolution. Naturally, this problem is compounded for larger displays containing longer wires.

U.S. Pat. No. 5,565,742 to Shichao et al. discloses a low voltage display wherein the cathode is broken up into shorter filaments to reduce the amount of sagging and for easier handling. This solution, however, introduces unnecessary and undesirable complexity to the display device. In addition, it compounds the cold terminal effect because the two terminal ends of the filament in a cathode are colder than the intermediate portion. The result is a nonuniform emission of electrons along the length of the filament, and resulting dark spots in the display. By breaking up long filaments into a greater number or shorter filaments, there are more terminal ends, and the cold terminal effect is compounded.

Shichao et al. also teach a method of reducing the amount of sagging by mounting the two ends of the filament to the housing by use of a spring. The springs are adapted to allow for expansion and contraction of the cathode filaments so that tension the cathode wires is maintained throughout temperature variations. Because conventional springs typically have lower resistance than the filament and thus emit fewer electrons, the cold terminal effect is compounded. Finally, the use of end springs cause the filaments to be subject to harmonic vibration, especially where current through the filament is pulsed, as is common in less than 100 percent duty cycles.

U.S. Pat. No. 5,170,100 to Shichao et al. discloses a display device wherein end portions of the cathode filaments are bent into springs to reduce cold terminal effects. These springs would permit the cathode to expand or contract without sagging and the tension maintained by these springs in the filament would reduce the amplitude of vibrations. By bending the end portions of the filament core into springs, it is unnecessary to connect the core to a separate spring and also reduces dark areas of the display caused by cold terminal effects discussed above.

A cathode supported under tension by springs at each end is very susceptible to the effects of vibration due to physical shock and drive signal, which can result in instability of the level of electrons emitted from the cathode and produces visible noise on the display. The use of end springs also varies the electron beam landing positions so that a reliably clear display cannot be ensured. Accordingly, use of one or more end springs fixedly attached to the ends of the line cathode as disclosed in U.S. Pat. No. 4,980,613 to Miyama et al. may have attenuate vibration, but does so in a way that renders an unacceptable portion of the line cathode unusable. The result is a larger physical display envelope, with a smaller display surface area.

In order to prevent the vibration of the line cathodes, U.S. Pat. No. 4,812,716 to Miyama et al. discloses a vibration suppressing means. In particular, thin rod-shaped dampers are positioned on the ends of the line cathodes. Each vibration-preventing damper is made of a metal wire or a metal wire sheathed by insulative substance or made of insulated thin rod.

In summary, prior art displays disclose springs in conjunction with cathode filaments. Although the use of such springs may be practical for cathode filaments, it does not solve similar problems for the controlling wires in displays that must be spaced considerably closer together. Indeed, mounting springs on the terminals of adjacent controlling wires limits the minimum spacing between the wires, and consequently limits the resolution of the display. No prior art, however, discloses the use of springs to maintain tension in controlling wires, nor does any prior art permit very close spacing of adjacent controlling wires.

### OBJECTS AND ADVANTAGES OF THE INVENTION

In view of the above, it is an object of the present invention to provide an electron controlling system that avoids the above difficulties in the prior art. In particular, it is an object of the invention to provide a method and apparatus for permitting precise and stable positioning of adjacent control wires that have very small separations, thus allowing higher resolution displays which are stable throughout large temperature variations.

### SUMMARY OF INVENTION

In an embodiment of the invention a number of thermionic cathode filaments serve as an elongated electron source. An electron guiding grid having a number of controlling filaments arranged in parallel and spaced by a gating separation equivalent to one pixel is positioned before the front panel and exposed to the electron source. In order to maintain tension, the controlling filaments are shaped in the form of a flat spring along their entire length. Because the spring is not concentrated at the ends of the controlling filaments, but is distributed along its entire length, the required width of the spring is very small, thereby permitting the controlling filaments to be positioned very close to each other. With the springs under moderate tension, energies from shock and vibration, including those caused by momentary heating, are dissipated throughout each individual flat spring. Consequently, the present design permits displays with very high resolution. Moreover, because the spring is integrated with the wire, the design is simple and does not require complicated terminal mountings.

### BRIEF DESCRIPTION OF THE DRAWINGS

FIG. 1 A side view of a typical electrofluorescent display incorporating the improved grid structure.

FIG. 2 An isometric view of a portion of a flat panel display incorporating the improved grid structure.

FIG. 3 An isometric view of a portion of the improved grid structure showing in detail the flat springs and their relation to the phosphor stripes.

### DESCRIPTION

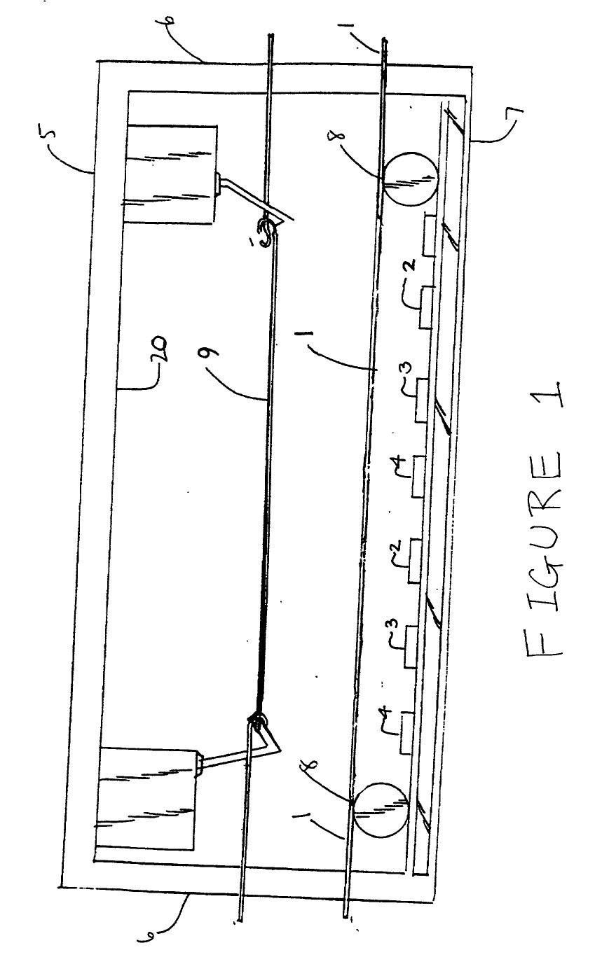

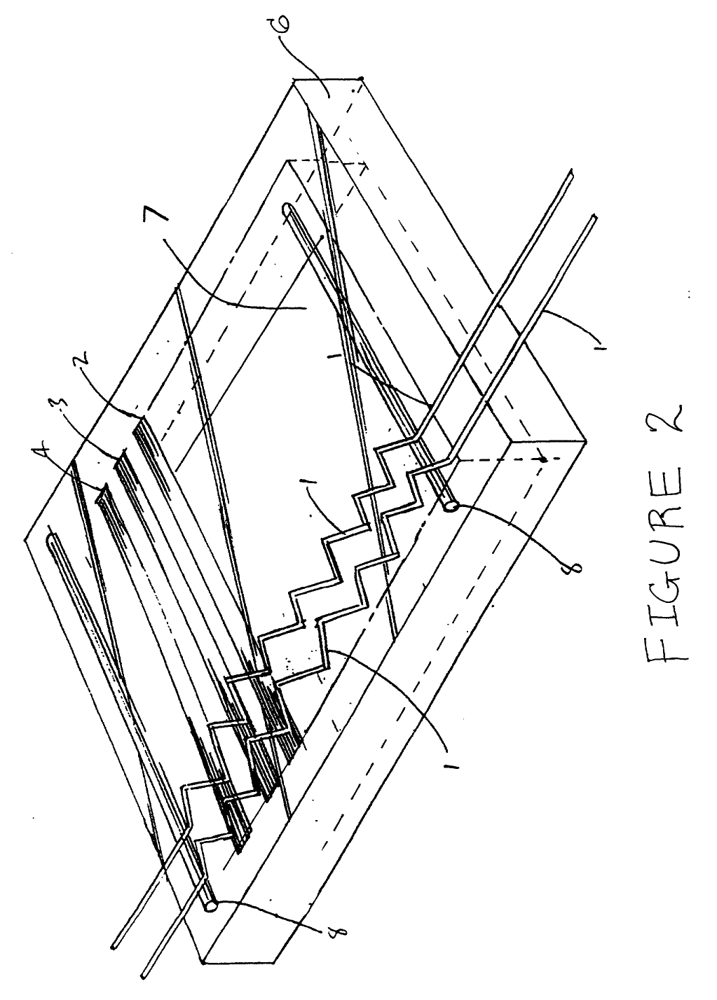

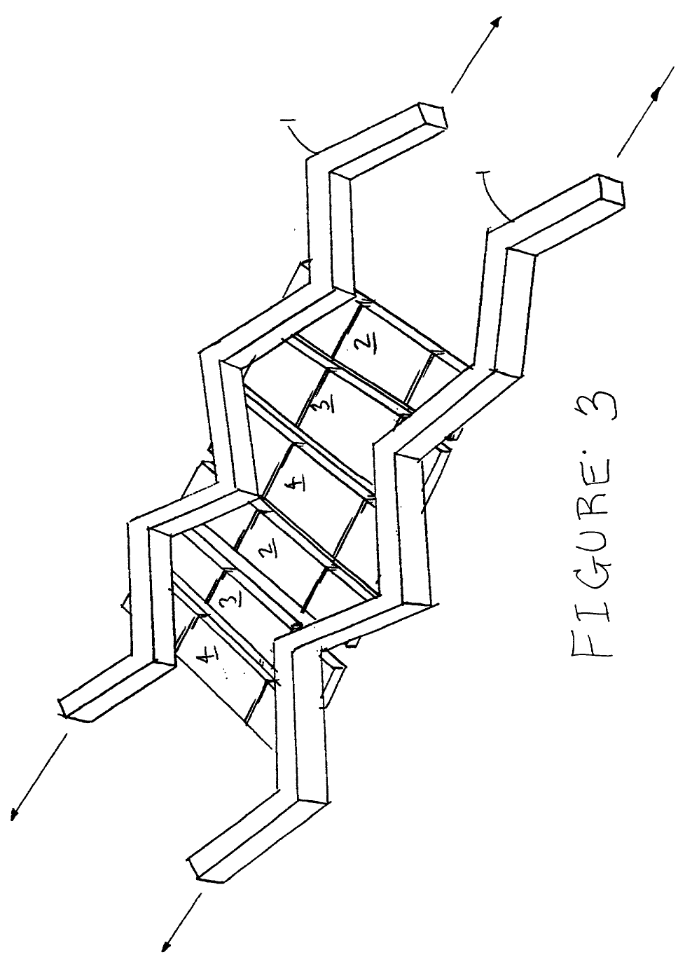

In an embodiment of the invention, the improved grid system is used in a flat panel display based on an electrofluorescent design. FIG. 1 illustrates a typical electrofluorescent display both according to the prior art and incorporating the temperature compensating grid system as the anode grid 1. From the view of FIG. 1, the present invention may appear substantially the same as the prior art, as the structure of the flat spring is most differentiated along an axis perpendicular to FIG. 1, as illustrated in FIGS. 2 and 3.

For reasons of clarity, only a portion of the system is shown in these Figures. A thermionic filament 9, as an elongated electron source, is energized and emits electrons while at the same time, a deflecting plate 2 is maintained at a negative voltage with respect to thermionic filament 9. Electrons emitted or “boiled off’ from thermionic filament 9 are reflected toward the anode grid 1 by deflecting plate 20. Portions of anode grid 1 and the phosphor stripes 2, 3 and 4, said phosphor stripes consisting of one or more kinds of phosphor each bonded to individual metalized stripes, are selectively energized to a positive potential by a control means external from the display. By selectively raising a positive potential on one or more anode grid 1 structures or wires and one or more phosphor stripes 2, 3 or 4, electrons pass through portions of the anode grid 1 toward the metalized base of the phosphor stripe 2, 3 or 4 and thereby impact the phosphors bonded to the metalized base. Usually, a housing comprised of a backplate 5 sealed against a glass or ceramic collar 6, which in turn is sealed against the front plate 7, encases entire apparatus and ensures a good vacuum. A vacuum is necessary for operation of the display. The display is usually viewed through the front plate 7, although a number of prior art displays of similar design are viewed through backplate 5 and the various filaments and grid structures.

The instant invention overcomes the limitations of the cold terminal effects of end spring systems of the prior art and solves the heat induced sag problem by substituting flat springs for wires in the anode grid. The anode grid 1 in FIG. 2 illustrates the use of a flat spring instead of grid wires. With the flat spring under moderate tension, i.e., wherein such tension which does not distend the length of the flat spring more that one-third of its neutral length, necessary resilience is maintained to accommodate temperatures up to 400° C. Vibration and shock integrity is preserved up to the failure of material used in connection with spacers 8 and the collar 6 to hold the flat springs in position.

In an enhancement to the embodiment described herein, the flat springs may be coated with a flat black material such as Aquadag on one side, and a highly reflective material such as silver on the other. Flat springs coated in this manner and positioned such that the side coated with the highly reflective material faces the thermionic filament will have greater thermal tolerance than similar uncoated flat springs. It is believed that coated flat spring forming anode grids will have thermal tolerance at least up to the point of thermal failure of the Soda Lime glasses commonly used in the face plate 7. It should be noted that applying similar coatings to ordinary grid wires as known in the prior art will provide a similar advantage in thermal response.

In the present embodiment of the invention, common spring metal such as Inconel X-750, a nickel-iron alloy, and its equivalents are etched by conventional chemical means to form a multitude of flat springs whose thickness is approximately 0.005 inch. The number of flat springs necessary for a particular display is determined by the size of the display and the resolution required. Such resolution is a function of the horizontal spacing of the flat springs used as the anode grids 1 and horizontal spacing of the phosphor stripes 2, 3 and 4, and whether the display is monochrome or color. While a monochrome display will use one phosphor compound, a color display will typically use three phosphor compounds as are commonly used in color television cathode ray tubes (hence the separate reference numerals for phosphor stripes 2, 3 and 4). However, the improved grid may be used to direct electrons to a multitude of phosphor compounds, including those emitting outside of the visible spectrum.

Displays of higher resolution require closer anode grid 1 and phosphor stripe 2, 3 and 4 spacing. In a typical display having VGA resolution the addressable phosphor target or pixel managed by the control means consists of a 0.2625 inch square portion or less of a phosphor stripe. As earlier discussed, closer anode grid 1 spacing increases the possibility of short circuits among the grid wires due to shock, vibration, and temperature induced sag.

FIGS. 2 and 3 provide additional views of an embodiment of the invention showing how the wave design of the flat spring overcomes the inherit limitations of round springs where close grid element separation is required. In FIG. 2, where the number of flat springs comprising the anode grid 1 and the number of phosphor stripes 2, 3, and 4, on a glass substrate 7 are reduced for clarity, it may be observed that the flat springs mesh conveniently and with stability. Such meshing is not practical for round springs where the grid elements are required to have spacing up to 0.02625 inch while maintaining a constant 0.015 inch over the orthogonally positioned phosphor stripes.

It is a further advantage of the invention that due to the wave design of the flat spring, the thermionic filament 9, as seen in FIG. 1, could be positioned above the anode grid 1 in either a parallel or orthogonal position. The advantage of either configuration depends upon the height of the thermionic filament 9 over the anode grid 1 and the intensity of the drive current applied to such filament.

### SUMMARY, RAMIFICATIONS, AND SCOPE

Many improvements can be added to the temperature-compensating grid apparatus described above. The flat spring element can be applied to thermionic filaments or to systems using multiple grids located above or below the thermionic filament or the phosphor stripes. Therefore, the scope of the invention should be determined, not by examples given, but by the appended claims and their legal equivalents.

We claim:

1. A grid system for a flat-panel display comprising:
a plurality of flat springs for deflecting and combining electrons from an elongated electron source toward a phosphor anode.

2. A grid system according to claim 1 wherein said springs are positioned medially between said elongated electron source and said phosphor anode.

3. A grid system according to claim 2 wherein said springs are positioned parallel to said elongated electron source and orthogonal to said phosphor anode.

4. A grid system according to claim 2 wherein said springs are positioned orthogonally to said elongated electron source and orthogonal to said phosphor anode.

5. A grid system according to claim 1 wherein said springs have variable widths.

6. A grid system according to claim 1 wherein said flat springs are formed in a wave pattern.

7. A grid system according to claim 1 wherein the side of said flat springs facing said elongated electron source is coated with a high temperature reflective coating and the side of said flat springs facing said anode is coated with black non-reflecting high temperature coating.

8. A grid system for a flat-panel display comprising:
a plurality of flat springs for deflecting and combining electrons from an elongated electron source toward a phosphor anode;
wherein the side of said flat springs facing said elongated electron source is coated with a high temperature reflective coating and the side of said flat springs facing said anode is coated with black non-reflecting high temperature coating.

9. A grid system for a flat-panel display comprising:
a plurality of grid wires for deflecting and combining electrons from an elongated electron source toward a phosphor anode;
wherein the side of said grid wires facing said elongated electron source is coated with a high temperature reflective coating and the side of said grid wires facing said anode is coated with black non-reflecting high temperature coating.

10. A flat spring for a flat panel display grid comprising:
an elongated member chemically etched from sheet metal.
